(19) United States
(12) Patent Application Publication
(10) Pub. No.: US 2024/0068821 A1
(43) Pub. Date: Feb. 29, 2024

(54) DRIVE ROUTE GENERATION DEVICE, DRIVE ROUTE GENERATION METHOD, AND STORAGE MEDIUM

(71) Applicant: TOYOTA JIDOSHA KABUSHIKI KAISHA, Toyota-shi (JP)

(72) Inventors: Taizo MASUDA, Yokohama-shi (JP); Kiyoto SASAKI, Susono-shi (JP); Daisuke KAKUMA, Toyota-shi (JP); Hiroyoshi MASUI, Susono-shi (JP); Akihiro YAMAGUCHI, Toyota-shi (JP); Sokfan YEE, Toyota-shi (JP); Yuki NISHIKAWA, Numazu-shi (JP)

(73) Assignee: TOYOTA JIDOSHA KABUSHIKI KAISHA, Toyota-shi (JP)

(21) Appl. No.: 18/332,315

(22) Filed: Jun. 9, 2023

(30) Foreign Application Priority Data
Aug. 25, 2022 (JP) 2022-133960

(51) Int. Cl. G01C 21/34

(52) U.S. Cl. CPC G01C 21/343

(57) ABSTRACT

The drive route generation device according to the present disclosure is configured to execute a process of acquiring a designated point, a process of acquiring a designation condition for a drive route to be generated, a process of selecting one or a plurality of specific spots from a plurality of spots based on the position information and the designation condition for the plurality of spots, and a process of generating, as a drive route, a circulation route that comes back to a designated point via one or a plurality of specific spots using the designated point as a departure point.

### CROSS-REFERENCE TO RELATED APPLICATION

This application claims priority to Japanese Patent Application No. 2022-133960 filed on Aug. 25, 2022, incorporated herein by reference in its entirety.

### BACKGROUND

### 1. Technical Field

The present disclosure relates to a technique for providing a tourism service. In particular, the present disclosure relates to a technique for generating a drive route of a mobility.

### 2. Description of Related Art

Japanese Unexamined Patent Application Publication No. 2020-134953 (JP 2020-134953 A) discloses an information processing device including a control unit that executes identifying a facility corresponding to a user attribute including a user's needs, preferences, or characteristics, and outputting information on a facility that has not been visited from the identified facilities to the user.

### SUMMARY

Conventionally, when a user goes sightseeing using a mobility such as a bus, a taxi, or a private vehicle, the user usually gets out of the mobility and enjoys sightseeing after moving to a specific spot. Such a mode of sightseeing is considered to be undesirable for a user who hesitates to get out of the mobility due to a social situation or the like, or for a user who is difficult to frequently get on or off the mobility.

One object of the present disclosure is to provide a technique capable of allowing a user to enjoy sightseeing without getting out of the mobility in view of the above problem.

A first aspect of the present disclosure relates to a drive route generation device that generates a drive route of a mobility.

The drive route generation device according to the first aspect is configured to perform:
a first process of acquiring a designated point;
a second process of acquiring a designation condition for the drive route to be generated;
a third process of selecting one or more specific spots from a plurality of spots based on position information on the spots and the designation condition; and
a fourth process of generating, as the drive route, a circulation route in which the mobility returns to the designated point via the one or more specific spots with the designated point as a starting point.

A second aspect of the present disclosure relates to a drive route generation method in which a computer generates a drive route.

The drive route generation method according to the second aspect includes the following:
acquiring a designated point;
acquiring a designation condition for the drive route to be generated;
selecting one or more specific spots from a plurality of spots based on position information on the spots and the designation condition; and
generating, as the drive route, a circulation route in which the mobility returns to the designated point via the one or more specific spots with the designated point as a starting point.

A third aspect of the present disclosure relates to a storage medium storing a drive route generation program that causes a computer to execute a process of generating a drive route of a mobility.

The storage medium according to the third aspect stores the drive route generation program configured to cause the computer to execute:
a first process of acquiring a designated point;
a second process of acquiring a designation condition for the drive route to be generated;
a third process of selecting one or more specific spots from a plurality of spots based on position information on the spots and the designation condition; and
a fourth process of generating, as the drive route, a circulation route in which the mobility returns to the designated point via the one or more specific spots with the designated point as a starting point.

According to the present disclosure, one or more specific spots are selected from a plurality of spots based on position information on the spots and a designation condition. Then, a circulation route in which the mobility returns to the designated point via the one or more specific spots with the designated point as a starting point is generated as a drive route. Here, each of the spots may be a point where a mobility user can enjoy sightseeing without getting out of the mobility. With the above, the user can enjoy sightseeing without getting out of the mobility as the mobility moves in accordance with the generated drive route.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a database that manages location information for a plurality of spots;

FIG. 2 is a conceptual diagram for describing an example of a drive route generated by the drive route generation device according to the present embodiment;

FIG. 3 is a conceptual diagram for describing an example of a drive route generated by the drive route generation device according to the present embodiment;

FIG. 4 is a block diagram illustrating a preferred example of the configuration of the drive route generation device according to the present embodiment;

FIG. 5 is a block diagram illustrating an example of a configuration of an autonomous vehicle in a case where the drive route generation device according to the present embodiment is applied to the autonomous vehicle;

FIG. 6 is a flowchart illustrating an example of a process executed by the drive route generation device according to the present embodiment;

FIG. 7 is a flowchart illustrating an example of a process executed by the drive route generation device according to the present embodiment.

### DETAILED DESCRIPTION OF EMBODIMENTS

### 1. Overview

Hereinafter, an outline of functions provided by the drive route generation device according to the present embodiment will be described with reference to the drawings.

The drive route generation device according to the present embodiment provides a function of generating a drive route of mobility (hereinafter, also referred to as a “drive route generation function”). Here, the mobility is capable of moving on a person or an object, and the form of the mobility is not particularly limited. Examples of the mobility include passenger cars, buses, small electrified vehicle, and riding vehicles. Also, the generated drive route typically provides a route on the map. The map to which the drive route is given may be a suitable map depending on the form of mobility. In the following description, mobility is assumed to be a passenger car, and a map to which a drive route is given is assumed to be a general road map.

The drive route generation device according to the present embodiment is configured to be connected to a database (hereinafter, also referred to as a “location information database”) that manages location information about a plurality of spots. Alternatively, the drive route generation device according to the present embodiment is configured to hold a position information database. For example, the drive route generation device is configured to be able to communicate with a data server that stores a location information database. Alternatively, the drive route generation device includes a storage device that stores a position information database.

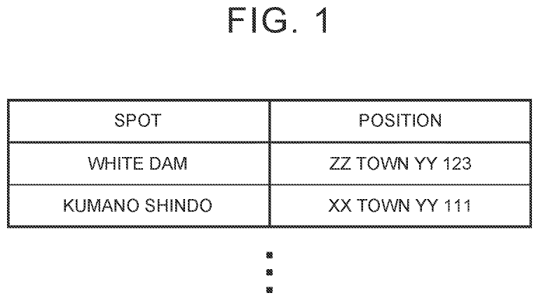

The location information database manages at least a location on the map for each of the plurality of spots. FIG. 1 schematically illustrates an example of a location information database. In FIG. 1, the position on the map for each of the plurality of spots is managed by an address. The location information database may manage locations on the map in other forms. For example, the location information database may be configured to manage locations on a map with coordinates.

Here, each of the plurality of spots managed by the location information database is a point where a mobility user can enjoy without getting out of mobility. Typically, each of the plurality of spots is a scenic spot. In this case, the position on the map managed by the position information database may be a passing point where the corresponding spot can be well viewed. Further, the location information database may be configured to manage specific conditions for each of the plurality of spots. For example, the location information database may be configured to manage a good viewing time and a good viewing time for spots having different scenery depending on time and time. In addition, the location information database may be configured to manage classification for each of the plurality of spots. For example, the location information database may be configured to manage tagging, such as natural, historical buildings, landmarks, and events, for each of the plurality of spots.

In the drive route generation function, the drive route generation device acquires a designated point and a designation condition for the drive route to be generated. Thereafter, the drive route generation device selects one or a plurality of specific spots from the plurality of spots based on the position information database and the designation condition. Then, the drive route generation device generates, as a drive route, a circulation route that comes back to the designated point via the selected one or more specific spots with the designated point as a departure point. Here, the designated point may be a point on the map designated by the user, or may be a current location of mobility. Further, the designation condition includes, for example, a condition related to a required time of a drive route to be generated (required time condition), a range on a map that defines a position of a specific spot to be selected, a condition related to the number of specific spots to be selected, a condition related to a classification of the specific spot to be selected, and the like.

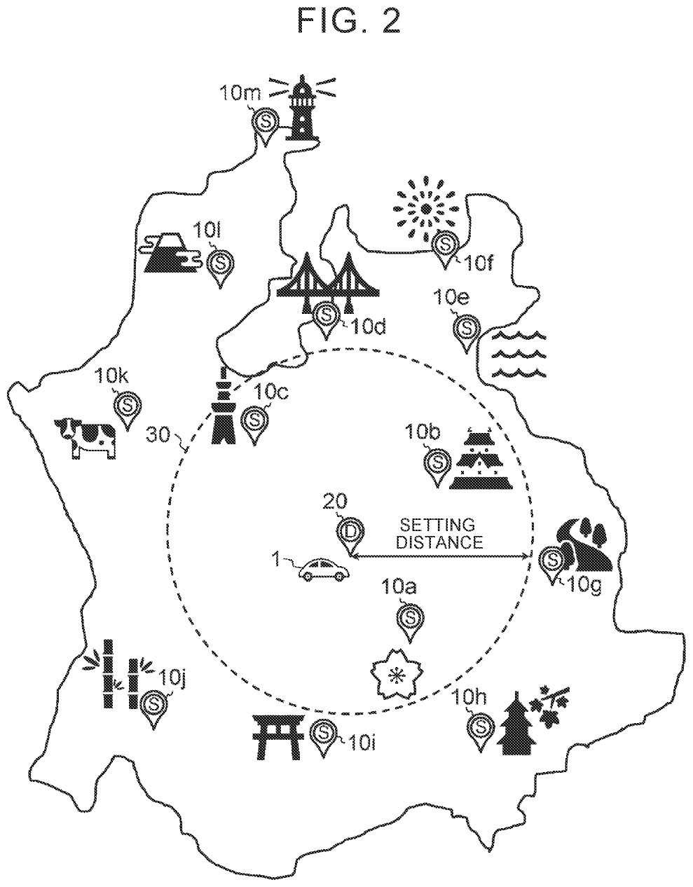

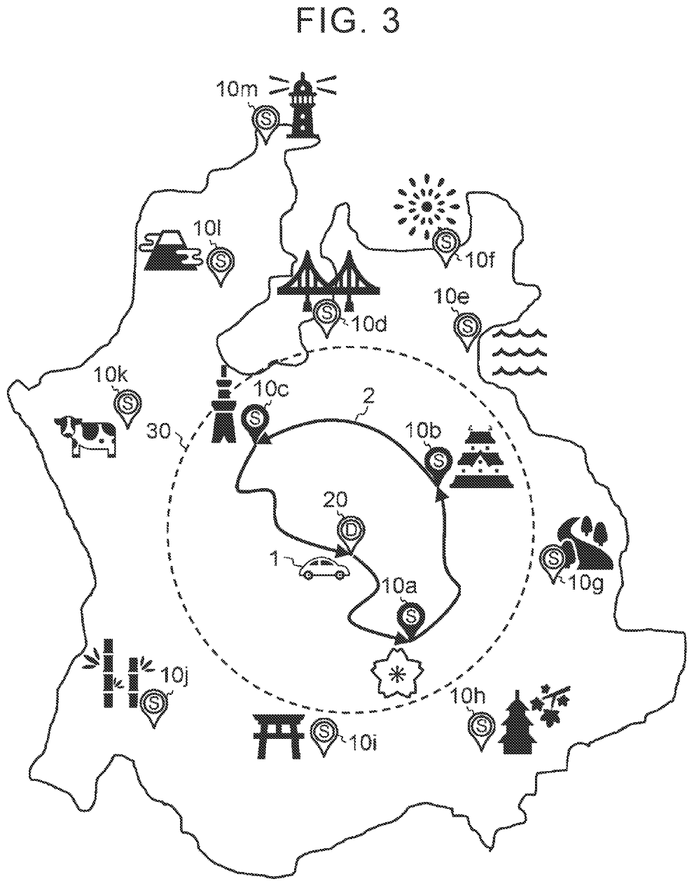

Referring to FIGS. 2 and 3, an example of a drive route generated by the drive route generation device according to the present embodiment will be described. In FIG. 2 and FIG. 3, a plurality of spot 10a, 10b, 10c in which position information is managed by a position information database in a certain area are illustrated.

In FIGS. 2 and 3, the drive route generation device acquires the current location of the mobility 1 as the designated point 20. FIG. 2 and FIG. 3 show cases where the drive route generation device selects the spot 10a, 10b and 10c as the specific spots. Therefore, as illustrated in FIG. 3, the drive route generation device generates, as a drive route, the circulation route 2 which is returned to the designated point 20 through the spot 10a, 10b and 10c with the designated point 20 as a departure point. The order of passing may be determined using the required time and the like as an index.

Here, the selection of one or a plurality of specific spots may be performed by a suitable method according to a designation condition. For example, as illustrated in FIG. 2, when the drive route generation device acquires the range 30 on the map as the designation condition, the drive route generation device may be configured to select the spot 10a, 10b and 10c as the specific spot because the drive route generation device is included in the range 30 on the map. In addition, in a case where the condition related to the classification of the specific spot selected by the drive route generation device is acquired as the designation condition, one or a plurality of specific spots may be selected from the spots corresponding to the designated classification among the plurality of spots. These designation conditions may be combined. Further, when the location information database manages a specific condition for each of the plurality of spots, the selection of the one or more specific spots may be configured to be selected from the plurality of spots satisfying the specific condition.

In particular, when the drive route generation device acquires the required time condition (for example, 60 minutes) as the designation condition, the drive route generation device can be configured to select one or a plurality of specific spots from the plurality of spots as follows.

First, the drive route generation device calculates a distance (set distance) according to the acquired required time condition. Here, the set distance may be determined in advance according to the required time condition. For example, the set distance is determined as 5 km, 10 km, 15 km for each of the required time conditions of 30 minutes, 60 minutes, and 90 minutes. This can be realized by a table or a map that gives a set distance to a required time condition. Next, the drive route generation device selects, as the specific spot, a spot whose linear distance from the designated point 20 among the plurality of spots is equal to or smaller than the calculated set distance. For example, in the situation illustrated in FIG. 2, the drive route generation device selects the spot 10a, 10b and 10c included in a circular range 30 determined by the set distance as the specific spot.

The length of the path of the circulation route 2 through one or more specific spots is in most cases correlated with the size of the area surrounded by the circulation route 2. Therefore, by selecting a spot having a straight line distance from the designated point 20 within a certain range as a specific spot, it is expected that the required time of the circulation route 2 is limited within a certain time. Therefore, by configuring the drive route generation device as described above, it is possible to select one or a plurality of specific spots that can be expected to satisfy the required time condition of the circulation route by a simple process. In addition, in the case where the required time condition is acquired as the designation condition, the processing cost can be reduced.

When the required time of the circulation route exceeds the required time condition, the drive route generation device may be configured to reduce the selected one or more specific spots. Here, the drive route generation device may be configured to give a priority to each of the selected one or more specific spots. The drive route generation device may be configured to reduce the selected one or more specific spots based on the priority. For example, the drive route generation device excludes spots having a low priority from the selected one or more specific spots until the required time of the circulation route satisfies the required time condition. With such a configuration, it is possible to ensure that the required time condition is satisfied, and it is possible to improve usability. Note that the priority may be given based on various indices. For example, a distance from the designated point 20 or a score (for example, a user evaluation of a landscape) calculated in advance may be used as an index.

As described above, the drive route generation device according to the present embodiment holds a location information database and a connection or a location information database for managing location information about a plurality of spots. Here, each of the plurality of spots managed by the location information database is a point where the user of mobility 1 can enjoy without going down from mobility 1. Further, according to the drive route generation device of the present embodiment, one or a plurality of specific spots are selected from the plurality of spots based on the position information database and the designation condition. Then, the circulation route 2 returning to the designated point 20 via one or a plurality of specific spots with the designated point 20 as a starting point is generated as a drive route. As a result, the user can enjoy tourism without going down from the mobility 1 by moving according to the drive route in which the mobility 1 is generated.

### 2. Configuration

Hereinafter, a configuration of a drive route generation device according to the present embodiment will be described with reference to the drawings.

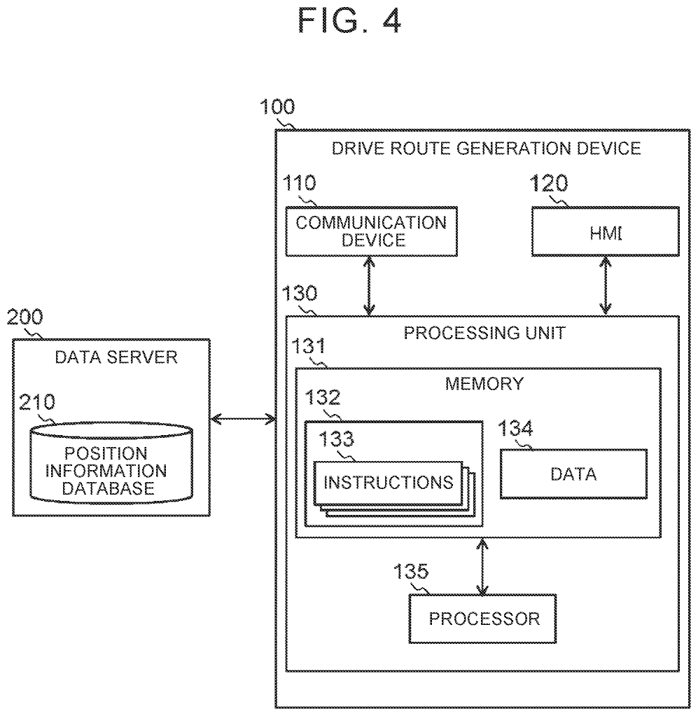

FIG. 4 is a block diagram illustrating a preferable example of the configuration of the drive route generation device 100 according to the present embodiment. In FIG. 4, the drive route generation device 100 includes a communication device 110, a HMI 120, and a processing unit 130. The processing unit 130 is configured to communicate with the communication device 110 and HMI 120. For example, the processing unit 130 is electrically connected to the communication device 110 and HMI 120 via a cable.

The communication device 110 communicates with an external device of the drive route generation device 100 to transmit and receive information. In particular, the communication device 110 includes a device for communicating with a data server 200 that stores a position information database 210. For example, the communication device 110 includes a device that connects to and communicates with a communication network (typically the Internet) to which the data server 200 is connected. That is, the drive route generation device 100 can be connected to the position information database 210 by the communication device 110. Information acquired by communication by the communication device 110 is transmitted to the processing unit 130.

A HMI 120 is a device that provides a Human Machine Interface (HMI) function to a user. Examples of HMI 120 include a display, a speaker, a touch panel, switches, indicators, and an operating panel. In particular, HMI 120 is configured such that the designated point 20 and the designation condition can be inputted by the user's manipulation. That is, the drive route generation device 100 acquires the designated point 20 and the designation condition via HMI 120. However, the drive route generation device 100 may be configured to acquire the current location of the mobility 1 as the designated point 20. In this case, the drive route generation device 100 acquires the current location of the mobility 1 via the communication device 110, for example. The data inputted in HMI 120 is transmitted to the processing unit 130.

HMI 120 may be configured such that the user can confirm the drive route generated by the drive route generation device 100. For example, HMI 120 displays a map and a drive route on the map on a display.

The processing unit 130 executes processing related to the drive route generation function. The processing unit 130 is a computer including a memory 131 and a processor 135.

The memory 131 is coupled to the processor 135 and stores a plurality of instructions 133 executable by the processor 135 and various data 134 necessary for executing the processing. Here, the plurality of instructions 133 are given by the computer program 132 (drive route generation program). Examples of the various types of data 134 include information related to the position information database 210 transmitted from the communication device 110, a table and a map that give a set distance to the designated point and the designation condition transmitted from HMI 120, and the required time condition.

The plurality of instructions 133 are configured to cause the processor 135 to execute processing related to the drive route generation function. In particular, the processor 135 operates in accordance with the plurality of instructions 133 to realize processing related to the drive route generation function.

The processing unit 130 outputs the drive route generated by executing the processing related to the drive route generation function. The drive route generation device 100 may be configured to transmit the drive route outputted by the processing unit 130 to an external device via the communication device 110, or may be configured to present the drive route to a user via a HMI 120. Alternatively, it may be configured to do both.

As described above, the drive route generation device 100 according to the present embodiment can be configured. The drive route generation device 100 may be configured to hold the position information database 210 as data 134 stored in the memory 131.

As an example of another configuration, a computer that partially functions as the drive route generation device 100 may be configured. For example, as a computer that partially functions as the drive route generation device 100, there is an Electronic Control Unit (ECU that is provided in the autonomous vehicle and executes a process related to the autonomous driving function when the mobility 1 is the autonomous vehicle).

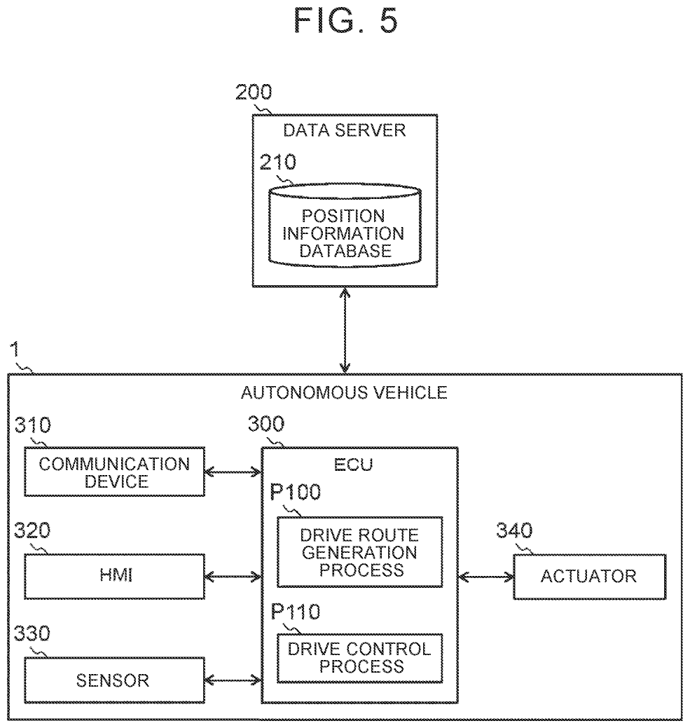

FIG. 5 shows an exemplary configuration in which the mobility 1 is the autonomous vehicle 1 and ECU 300 partially functions as the drive route generation device 100. In FIG. 5, the autonomous vehicle 1 includes an ECU 300, a communication device 310, a HMI 320, a sensor 330, and an actuator 340. ECU 300 is configured to communicate with the communication device 310, HMI 320, the sensor 330, and the actuator 340. For example, each of the devices is connected to an in-vehicle network configured by Control Area Network (CAN) or the like.

The communication device 310 communicates with an external device of the autonomous vehicle 1 to transmit and receive information. In particular, the communication device 310 includes a device for communicating with a data server 200 that stores a position information database 210. The data acquired by the communication device 310 through the communication is transmitted to ECU 300. That is, the communication device 310 enables ECU 300 to be connected to the position information database 210. Examples of the information transmitted from the communication device 310 to ECU 300 include map information, road traffic information, and GPS position information.

HMI 320 is a device that provides a HMI function to a user of the autonomous vehicle 1. In particular, HMI 320 is configured such that the designated point 20 and the designation condition can be inputted by the user's manipulation. The data inputted in HMI 320 is transmitted to ECU 300. That is, ECU 300 is configured to be able to acquire the designated point 20 and the designation condition by HMI 320. However, ECU 300 may be configured to acquire the designated point 20 as the current position of the autonomous vehicle 1. In this situation, ECU 300 acquires, for example, GPS position information acquired from the communication device 310 as the designated point 20.

The sensor 330 detects information related to the driving environment of the autonomous vehicle 1. Examples of the sensor 330 include a sensor that detects an ambient environment (a preceding vehicle, a white line, an obstacle, and the like) of the autonomous vehicle 1, and a sensor that detects a traveling state (a vehicle speed, an acceleration, a yaw rate, and the like) of the autonomous vehicle 1. The sensor for detecting the surroundings of the autonomous vehicle 1 is, for example, a camera, a millimeter-wave radar, or a Light Detection and Ranging (LiDAR). The sensor for detecting the traveling state of the autonomous vehicle 1 is, for example, a vehicle speed sensor, a G sensor, a gyro sensor, or the like. The data detected by the sensor 330 is transmitted to ECU 300.

ECU 300 executes a process related to the autonomous driving function based on the acquired data. In particular, ECU 300 is configured to execute the drive route generation process P100 and the drive control process P110 as processing related to the autonomous driving function. ECU 300 is typically a computer comprising memories and a processor. That is, in ECU 300, the processor operates in accordance with a plurality of instructions stored in the memories, so that the drive route generation process P100 and the drive control process P110 are executed.

The drive route generation process P100 is processing related to a drive route generation function, and a drive route of the autonomous vehicle 1 is generated by executing the drive route generation process P100. That is, ECU 300 functions as the drive route generation device 100 when ECU 300 executes the drive route generation process P100.

The drive control process P110 is processing for performing travel control of the autonomous vehicle 1 so as to travel in accordance with the generated drive route. By executing the drive control process P110, a control signal for causing the autonomous vehicle 1 to travel is generated according to the generated drive route. The generated control signal is transmitted to the actuator 340.

The actuator 340 operates in accordance with a control signal transmitted from ECU 300. Examples of the actuator 340 include an actuator that is related to the operation of a power device (an internal combustion engine, an electric motor, or the like), an actuator that is related to the operation of a brake mechanism, and an actuator that is related to the operation of a steering mechanism. When the actuator 340 operates in accordance with the control signal, the autonomous driving of the autonomous vehicle 1 according to the generated drive route and, in turn, the autonomous driving of the autonomous vehicle 1 is realized.

In this way, a computer that partially functions as the drive route generation device 100 can be configured. Further, by configuring the mobility 1 (autonomous vehicle 1) as described above, it is possible to realize the mobility 1 in which the user can enjoy tourism without getting out of the mobility 1.

### 3. Processing

Hereinafter, a process related to a drive route generation function executed by the drive route generation device 100 according to the present embodiment will be described with reference to the drawings.

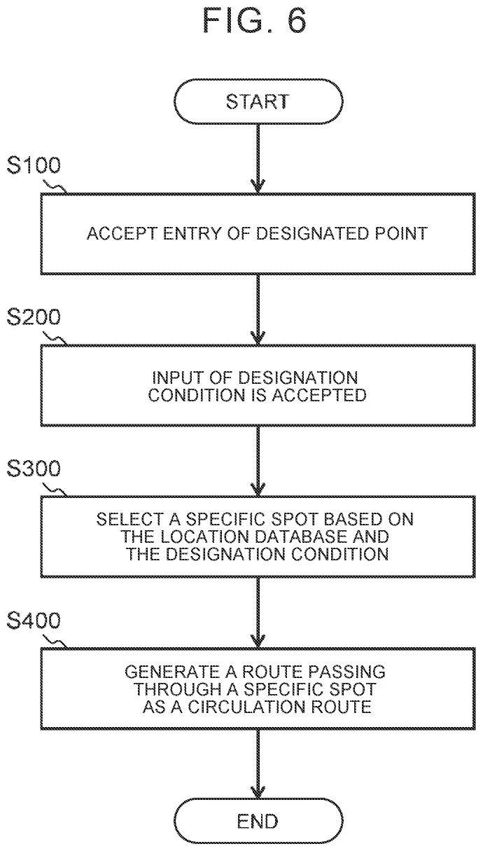

FIG. 6 is a flowchart illustrating an example of a process executed by the drive route generation device 100. The flowchart illustrated in FIG. 6 starts, for example, when the drive route generation device 100 is activated.

In S100 (first process), the drive route generation device 100 receives an entry of the designated point 20 via HMI 120 (HMI 320). However, when the designated point 20 is the current location of the mobility 1, the drive route generation device 100 may be configured to acquire the current location of the mobility 1. After S100, the process proceeds to S200.

In S200 (second process), the drive route generation device 100 receives an input of a designation condition via a HMI 120 (HMI 320). After S200, the process proceeds to S300.

In S300 (third process), the drive route generation device 100 selects one or a plurality of specific spots from the plurality of spots based on the position information database 210 and the designation condition received in S200. After S300, the process proceeds to S400.

In S400 (fourth process), the drive route generation device 100 generates, as a drive route, a circulation route 2 that comes back to the designated point 20 through one or more specific spots selected in S300 (third process), with the designated point 20 received in S100 as a departure point. After S400, the process ends. After S400, the drive route generation device 100 may further execute a process of presenting the generated drive route to the user of the mobility 1.

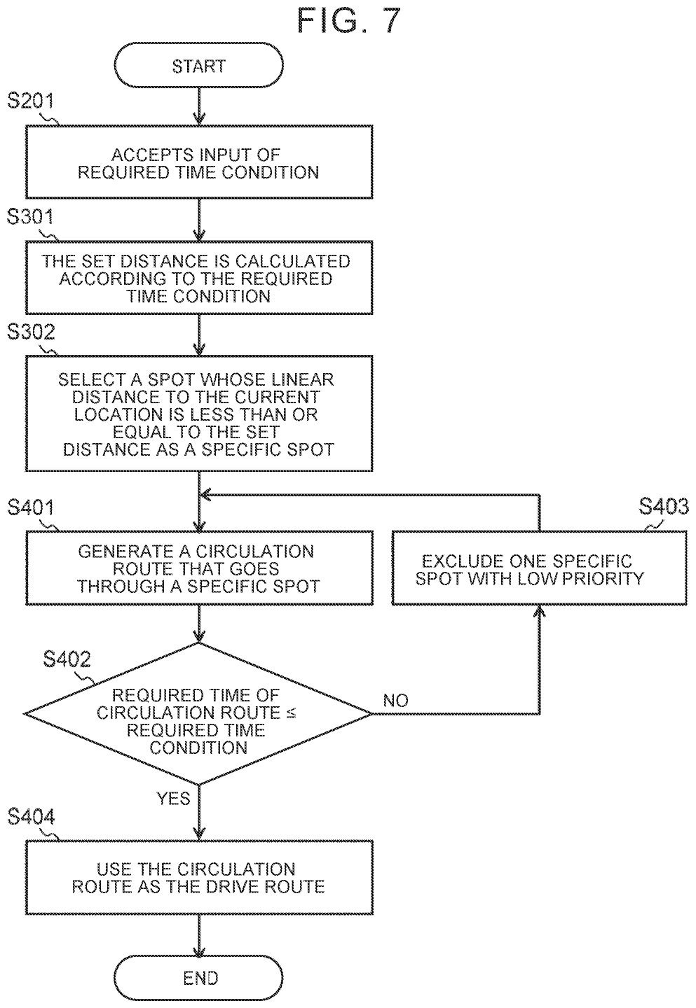

Here, in a case where the drive route generation device 100 acquires the current location of the mobility 1 as the designated point 20 and acquires the required time condition as the designation condition, a flowchart illustrated in FIG. 7 can be more specifically given as an example of the processing related to the drive route generation function executed by the drive route generation device 100. Hereinafter, the flowchart shown in FIG. 7 will be described.

In S201, the drive route generation device 100 receives the required time condition via HMI 120 (HMI 320). After S201, the process proceeds to S301.

In S301, the drive route generation device 100 calculates the set distance according to the required time condition received in S201. After S301, the process proceeds to S302.

In S302, the drive route generation device 100 selects, as one or a plurality of specific spots, a spot of which the linear distance from the current location of the mobility 1 is equal to or less than the set distance calculated in S301, among the plurality of spots. After S302, the process proceeds to S401.

In S401, the drive route generation device 100 generates a circulation route through the selected one or more specific spots. Then, the drive route generation device 100 determines whether the required time of the generated circulation route is equal to or less than the required time condition (S402).

When the required time of the generated circulation route is equal to or less than the required time condition (S402; Yes), the drive route generation device 100 sets the generated circulation route as a drive route (S404). Thereafter, the process ends.

When the required time of the generated circulation route exceeds the required time condition (S402; No), the drive route generation device 100 gives a priority to each of the selected one or more specific spots, and excludes one specific spot having a lower priority from the selection (S403). After that, the process returns to S401 again, and the process is repeated.

As described above, the process is executed by the drive route generation device 100. Alternatively, a computer program 132 (a drive route generation program) that causes the drive route generation device 100 to execute processing in this manner is realized. The program is stored in a storage medium. In addition, the drive route generation device 100 realizes a drive route generation method of generating a drive route of the mobility 1 in this manner.

What is claimed is:

1. A drive route generation device that generates a drive route of a mobility, the drive route generation device configured to perform:
a first process of acquiring a designated point;
a second process of acquiring a designation condition for the drive route to be generated;
a third process of selecting one or more specific spots from a plurality of spots based on position information on the spots and the designation condition; and
a fourth process of generating, as the drive route, a circulation route in which the mobility returns to the designated point via the one or more specific spots with the designated point as a starting point.

2. The drive route generation device according to claim 1, wherein:
the designation condition includes a required time condition of the drive route to be generated;
the third process includes calculating a set distance in accordance with the required time condition; and
the third process includes selecting, as the one or more specific spots, a spot in which a linear distance from the designated point is equal to or smaller than the set distance from among the spots.

3. The drive route generation device according to claim 2, wherein the fourth process includes:
assigning priority to each of the one or more specific spots; and
reducing the one or more specific spots based on the priority when a required time of the circulation route exceeds the required time condition.

4. The drive route generation device according to claim 1, wherein:
the designation condition includes specification of a range on a map; and
the third process includes selecting, as the one or more specific spots, a spot included in the range on the map from among the spots.

5. A drive route generation method in which a computer generates a drive route of a mobility, the drive route generating method comprising:
acquiring a designated point;
acquiring a designation condition for the drive route to be generated;
selecting one or more specific spots from a plurality of spots based on position information on the spots and the designation condition; and
generating, as the drive route, a circulation route in which the mobility returns to the designated point via the one or more specific spots with the designated point as a starting point.

6. A non-transitory storage medium storing a drive route generation program configured to cause a computer to perform a process of generating a drive route of a mobility, the drive route generation program comprising:
a first process of acquiring a designated point;
a second process of acquiring a designation condition for the drive route to be generated;
a third process of selecting one or more specific spots from a plurality of spots based on position information on the spots and the designation condition; and
a fourth process of generating, as the drive route, a circulation route in which the mobility returns to the designated point via the one or more specific spots with the designated point as a starting point.
